(19) United States
(12) Patent Application Publication
(10) Pub. No.: US 2006/0273087 A1
(43) Pub. Date: Dec. 7, 2006

(54) Lighted vessel for attachment to bottle

(76) Inventor: Ross B. Crawford, Seaford, NY (US)

Correspondence Address: HOFFMANN & BARON, LLP, 6900 JERICHO TURNPIKE, SYOSSET, NY, 11791, US

(21) Appl. No.: 11/142,958

(22) Filed: Jun. 2, 2005

(51) Int. Cl. B65D 51/00; G10K 1/00; F21S 10/00; A47G 19/22

(52) U.S. Cl. 220/212; 220/377; 116/202; 116/148; 220/703

(57) ABSTRACT

A drinking device for use with a container of potable liquid having a vessel portion for holding liquid and an attachment structure for attaching the device to the container of potable liquid is provided. In one embodiment, the device includes an illuminator to provide illumination to the device. In another embodiment, the device includes a sound generator to produce sound from the device. The device can also include both the illuminator and the sound generator.

### BACKGROUND OF THE INVENTION

The present invention relates to potable beverage containers, and more specifically, to auxiliary drinking vessels adapted for attachment to use with a bottle of potable liquid.

It has been known to provide a bottle for containing liquids with a cup assembly which can be attached to an open end of a bottle and be integral therewith in order to prevent spilling of liquid therefrom. In U.S. Pat. No. 6,209,737, such a device is disclosed wherein the cup assembly includes an attachment mechanism for attachment to the body of the open end of a bottle to allow a user to drink from the cup assembly while attached to the bottle. Similarly, U.S. Pat. No. 2,582,934 discloses an auxiliary drinking cup or vessel which is especially designed for quick and easy attachment to a bottle of a carbonated beverage, soft drink or similar liquid. DE 26 41 874 shows a cup-like device fitted into what appears to be the neck of a bottle.

As the field of bottle ware has developed over the years it has become a practice for specialty companies such as liquor companies, to package alcohol in miniature bottles designed to hold for example, 50 milliliters of an alcoholic beverage. A miniature bottle of alcohol is difficult to drink from since the opening from which the liquid is dispensed is small and narrow. Furthermore, it is generally considered socially unacceptable to drink directly from any bottle, let alone a mini-bottle. Thus it would be advantageous to alleviate the problem of drinking directly from such bottles while providing the travel industry with a method for promoting products so as to strengthen corporate and brand identities.

To that end, co-pending U.S. application Ser. No. 11/026,612 filed Dec. 30, 2004 (claiming benefit of Provisional Application No. 60/533,278, filed Dec. 30, 2003) discloses a drinking vessel designed to incorporate an alcoholic beverage container. The pending application, which is commonly owned, shows a drinking attachment for alcoholic bottles and the like which includes a vessel having a bottom adapted to fit over a capped bottle and thereby transform it into a sophisticated drinking cup.

None of the devices above, however, have been able to provide the container and potable liquid companies with a means for enhancing the novelty, appearance, and drinking experience through use of lighting and decorative features. To that end, the present invention is designed to overcome this shortcoming in the industry.

### SUMMARY OF THE INVENTION

The present invention is a drinking device for use with a container of potable liquid which includes a vessel portion having a side wall and a bottom which are continuous so that a liquid can be held therein. The device also includes an attachment structure joined to the vessel portion for attaching the device to a container which holds a liquid. Furthermore, the device of present invention includes an illuminator fixed in either the attachment structure or the vessel portion or a combination of the attachment structure and the vessel portion such that it can be operated to provide illumination to the device.

The vessel portion preferably emulates the top of a drinking glass such as those used for alcoholic beverages, e.g., a martini glass, a wine glass, a snifter, a fluted glass, and other glasses which routinely hold alcoholic beverages.

In one preferred embodiment the sidewall of the vessel is formed such that it is actually two walls which are cooperatively parallel over the entire shape of the vessel. In this case, the side wall includes an outside wall and an inside wall and an opening between the outside and the inside walls. The opening provided between the outside and inside walls is accessible by a user of the device for introducing and holding drink-enhancing substance. Such substance can be, for example, water or another liquid which can be frozen in order to cool the potable liquid which is subsequently poured into the vessel portion. Another substance which can be provided within the opening between the outside and inside walls of the vessel portion include decorative features, such as glitter, figurines, colored objects, colored liquid, a phosphorescing substance, etc.

The attachment structure can be an elongated casement extending from the outside of the vessel portion and having a shape and size to accommodate the insertion of a top of a container and a securement for securing the device to the container. The elongated encasement can be a continuous wall which encircles a top of a container and which has a bottom edge which fits conformingly against the outside surface of the container at a point below the top. The securement can be a grommet fixed on the inside of the elongated case which is sized to grip the top of the container. Alternatively, the securement can be a threaded surface for receiving a screw top of a container.

The illuminator can consist of a source of illuminating radiation, e.g., an electric light, and a source of power connected thereto for turning the source of illuminating radiation “on” so that the drinking device can be selectively illuminated. The illuminator can further include a switch for turning the source of illumination “on” and “off.” In one embodiment the switch operates to turn the light “on” when the device is attached to the container. Alternatively, the switch can operate to turn the light “off” when attached to the container and to turn the light “on” when the device is detached from the container.

In yet other embodiments, the switch can be operated manually to turn the light “on” and “off” and can even be operated remotely to turn the light “on” and “off”. The switch can be operated responsive to signals from the electromagnetic spectrum, such as radiowaves, etc.

Furthermore, the source of illumination can provide radiation selected from different frequencies of the electromagnetic spectrum, including ultraviolet, infrared, etc. Thus a “black” light can be generated as well as, for example, a strobe effect.

It has been found that the light can be at least one light emitting diode (LED), and, in a preferred embodiment three LEDs. In yet a further preferred embodiment, the light can be situated such that it radiates within the walls of the vessel portion.

In another embodiment, the device includes a sound generator in place of or, preferably, in addition to an illuminator. The sound generator can be fixed in the attachment structure or the vessel portion or a combination of the attachment structure and the vessel portion, so that it can generate sound from the device.

The sound generator can include a sound chip, a speaker and a source of electrical power connected to the sound chip and the speaker for energizing the sound chip and speaker, so the drinking device can selectively produce sound. The sound generator can further include a switch for turning the sound generator “on” and “off.” The sound generator can produce a discrete sound, a series of different sounds, music, a tone, a series of different tones, recorded voice, songs or jingles.

In one embodiment, the device includes both an illuminator and a sound generator which share a common source of electrical power for energizing both the illuminator and the sound generator. The illuminator and sound generator can also share a common switch for turning them “on” and “off.”

As a result of the present invention, manufacturer of liquids, especially alcoholic beverages, can provide the device in conjunction with liquids as a means of enhancing the drinking experience of the purchaser and can use the device as a way of increasing sales and marketing.

For a better understanding of the present invention, together with other and further objects, reference is made to the following description, taken in conjunction with the accompanying drawings, and the scope will be pointed out in the appended claims.

### BRIEF DESCRIPTION OF THE DRAWINGS

FIG. 1 is an exploded view of a drinking device in accordance with the present invention;

FIG. 2 is a schematic of a drinking device as the present invention attached to a container, i.e., on the top of a bottle, with a partial cutaway showing an illuminating assembly;

FIG. 3 is a elevated side cross-sectional view of the device as shown in FIG. 2;

FIG. 4 is yet a further embodiment of the present invention which includes an outer wall and an inner wall of the vessel portion such that a substance enhancing material can be introduced and held in the vessel portion;

FIG. 5 is another embodiment of the invention wherein the illumination is located at a junction of the vessel portion and the attachment structure; and

FIG. 6 is a side cross-sectional view of another embodiment of the device which includes a sound generator that emits sound via a speaker through the sidewall of the attached structure.

FIGS. 7A, B, C, D, E and F depict other possible shapes for the vessel portion.

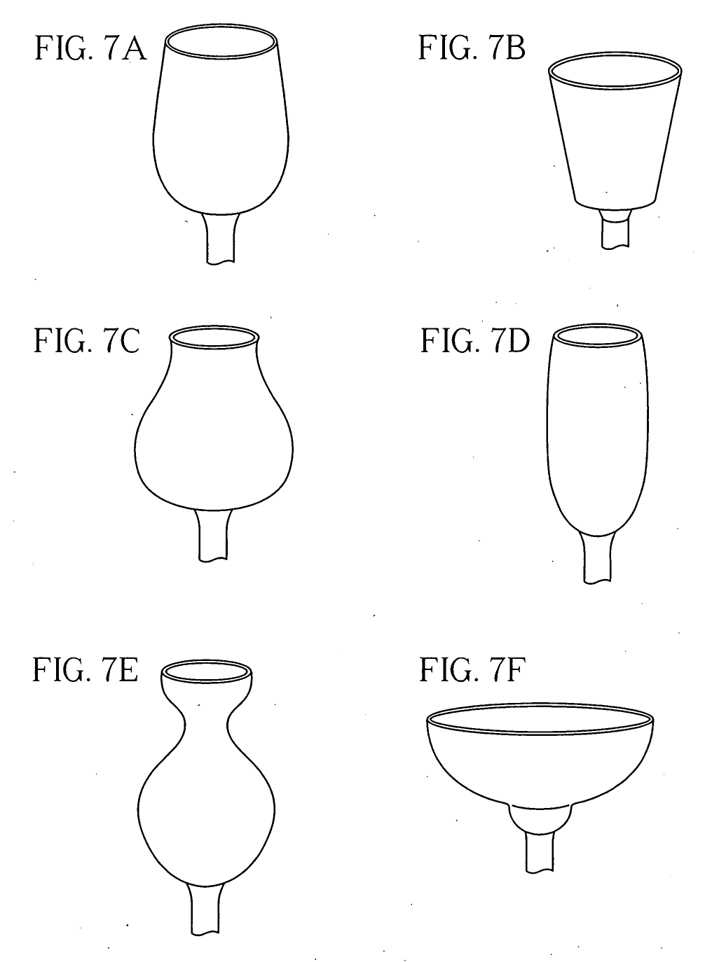

### DETAILED DESCRIPTION OF THE INVENTION

The present invention provides a drinking device for use with a container of potable liquid, e.g., a 50 ml liquor bottle. The drinking device includes a vessel portion having a side wall and a bottom which are continuous so that it can hold liquid, and an attachment structure joined to the vessel portion for attaching the device to the container of potable liquid. The device also includes an illuminator fixed in either the attachment structure, the vessel portion or a combination of the attachment structure and the vessel portion, such that the illuminator can be operated to provide illumination to the device.

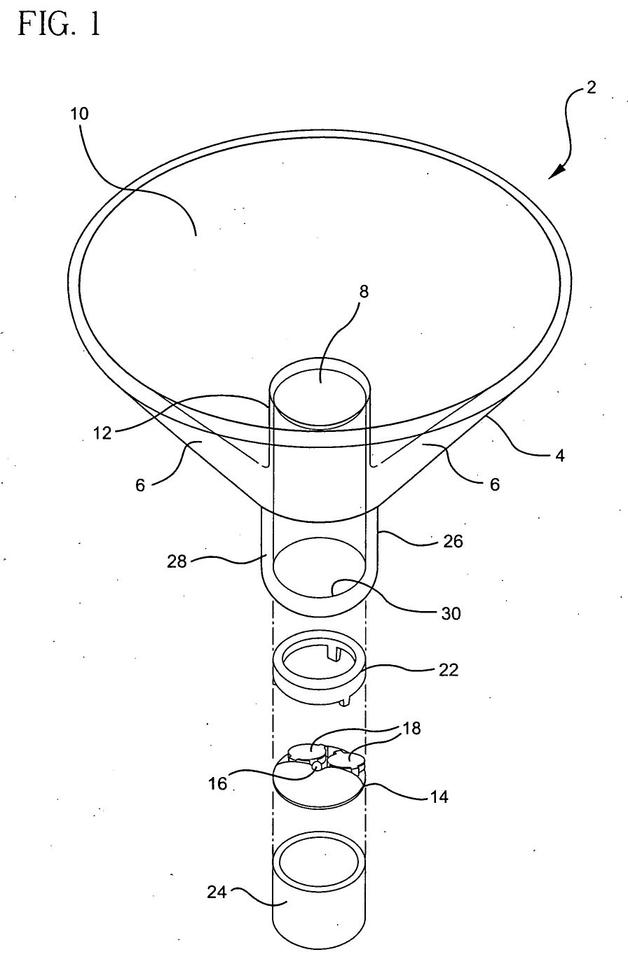

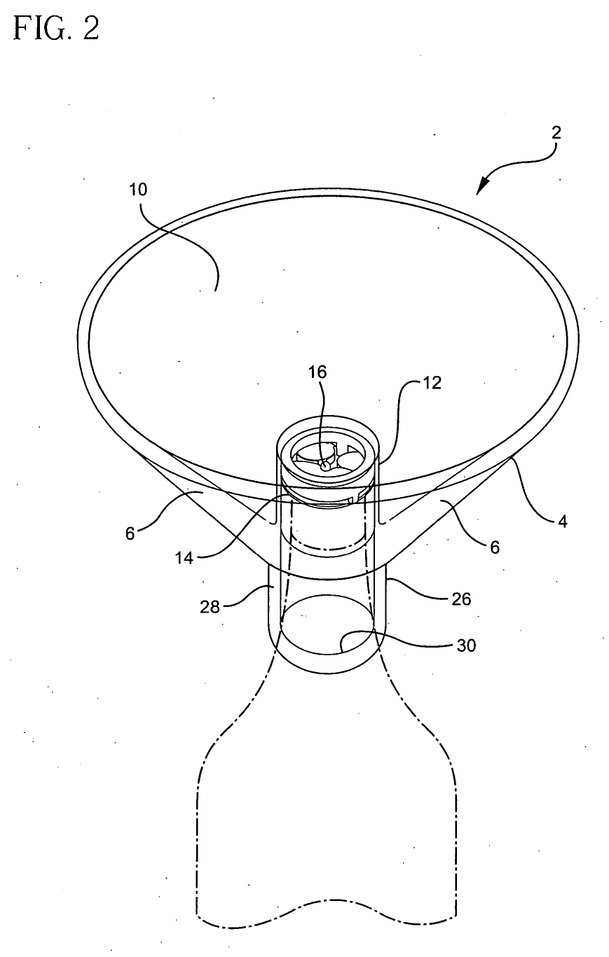

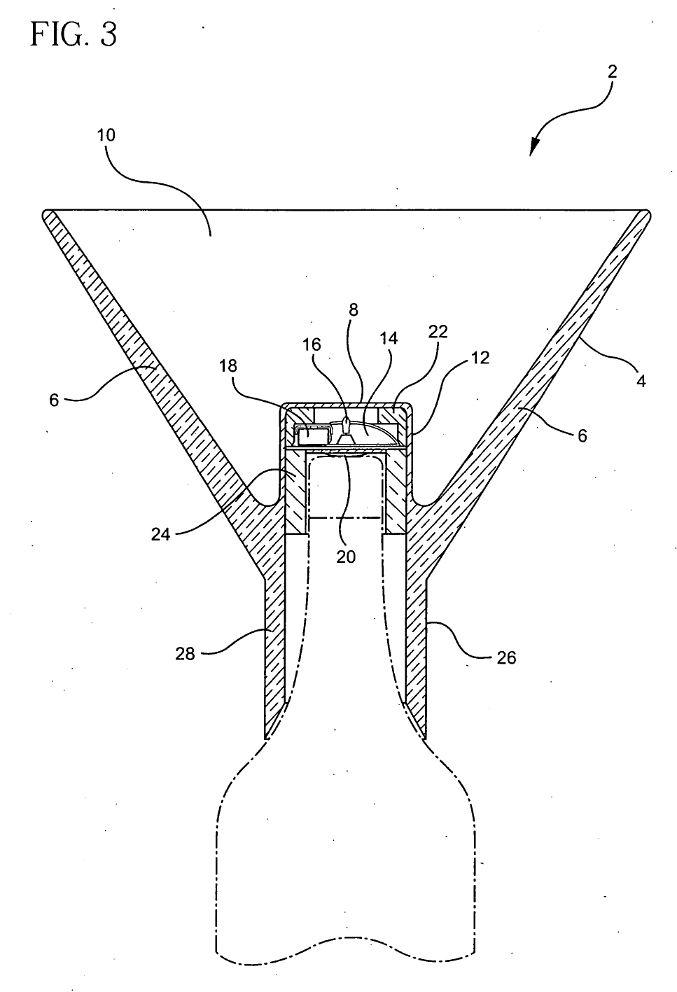

One embodiment of the invention provides a drinking device in which the vessel portion emulates the top of a martini glass. The vessel includes a bottom portion which projects upwardly into the vessel interior and which houses an illuminator. Referring to the drawings, there is shown in FIGS. 1-3, a drinking device 2 which includes a vessel portion 4 that emulates the top of a martini glass. The vessel portion 4 has a side wall 6 and a bottom portion 8 which is continuous, so that the sidewall 6 and bottom 8 form a vessel interior 10 that can hold liquid. The bottom portion 8 projects upwardly into the vessel interior 10 and forms a housing 12 which houses an illuminator 14. The illuminator 14 includes an LED 16, a power source 18 and a switch 20 for energizing or de-energizing the LED 16. The switch 20 can be switched by pressing it in, e.g., by the force of a bottle top upon fitting the drinking device 2 over a bottle. The illuminator 14 is held in place near the upper portion of the housing 12 by a stop ring 22 that is fit between the illuminator 14 and the underside of the wall forming the bottom 8 of the vessel 4 and a retaining ring 24 that retains the illuminator 14 in place.

As used herein, the term “LED” should be understood to include light emitting diodes of all types, light emitting polymers, semiconductor dies that produce light in response to current, organic LEDs, electro-luminescent strips, and other such systems. “LED” may refer to a single light emitting diode having multiple semiconductor dies that are individually controlled. It should also be understood that the term “LED” does not restrict the package type of the LED. The term “LED” includes packaged LEDs, non-packaged LEDs, surface mount LEDs, chip on board LEDs and LEDs of all other configurations. The term “LED” also includes LEDs packaged or associated with material (e.g., a phosphor) wherein the material may convert energy from the LED to a different wavelength. It is also contemplated that any powered light source can be used in place of the LED, such as, for example, an incandescent or fluorescent light bulb. Preferably, the light source emits visible light in wavelengths to produce a color selected from the group consisting of red, blue, green and violet. In one embodiment, the light source emits UV or black light.

The drinking device also includes an attachment structure 26 joined to the vessel portion 4 for attaching the device 2 to a container of potable liquid. The attachment structure 26 includes a side wall 28 which projects in the opposite direction from the opening of the vessel portion 4 and includes an opening 30, to provide an elongated casement having a shape and size to accommodate insertion of a top of a potable liquid container. The attachment structure 26 is continuous with the housing 12 so that the illuminator 14 and the neck of a bottle can be inserted through the opening 30 towards the underside of the wall forming the bottom 8 of the vessel 4. The stop ring 22, illuminator 14 and retaining ring 24 assembly is installed by being inserted through the opening 30 of the attachment structure 26. Preferably, the inside diameter of the retaining ring 24 is selected to closely fit and secure the top of a container, e.g., a bottle, to which the drinking device 2 is being attached.

The materials used for making the drinking device can include glass, synthetic resins (i.e., polymeric or plastic materials), and the like. The drinking device is preferably made from a rigid polymeric material. Preferably, at least a portion of the drinking device is transparent or translucent, so that the illuminator can emit light through the materials of the drinking device. More preferably, the drinking device is transparent to emulate the look of clear glass. Typical polymeric materials include organic, preferably transparent, polymers which can be molded, using conventional molding techniques, such as polyethylene, polypropylene, polystyrene, methacrylates, polyparamethyl styrene and the like. Materials that can withstand heat or sterilization by heating in steam without distortion or loss of transparency are preferred.

In addition to a clear transparent material, it is also contemplated that portions of, or the entire device, can be a color selected from the group consisting of red, orange, yellow, green, blue, indigo and violate. The device can also include areas of different colors or patterns. Preferably, at least a portion of the colored material is transparent or translucent. Coated plastic materials or molding techniques, which result in coatings or surface structures to improve the surface characteristics of the materials, e.g., inorganic coatings or variations in surface texture, are also contemplated. For example, at least a portion of the device can have a frosted appearance. The device can also include indicia, e.g., advertising, trademarks or tradenames for a particular brand of potable liquid.

The attachment structure is preferably an elongated encasement formed by a continuous wall which encircles a top of a container, e.g., a 50 ml liquor bottle, and which has a bottom edge which fits conformingly against the outside surface of the container at a location below the top. The attachment structure can also include a securement for securing the drinking device to the container. The securement can be a grommet fixed on the inside of the elongated case which is sized to grip the top of the container. The grommet is preferably made from rubber or a like resilient material which has a gripping effect on the container top. It is also contemplated that the securement can be a threaded surface for receiving a screw top of a container, e.g., a threaded 50 ml liquor bottle.

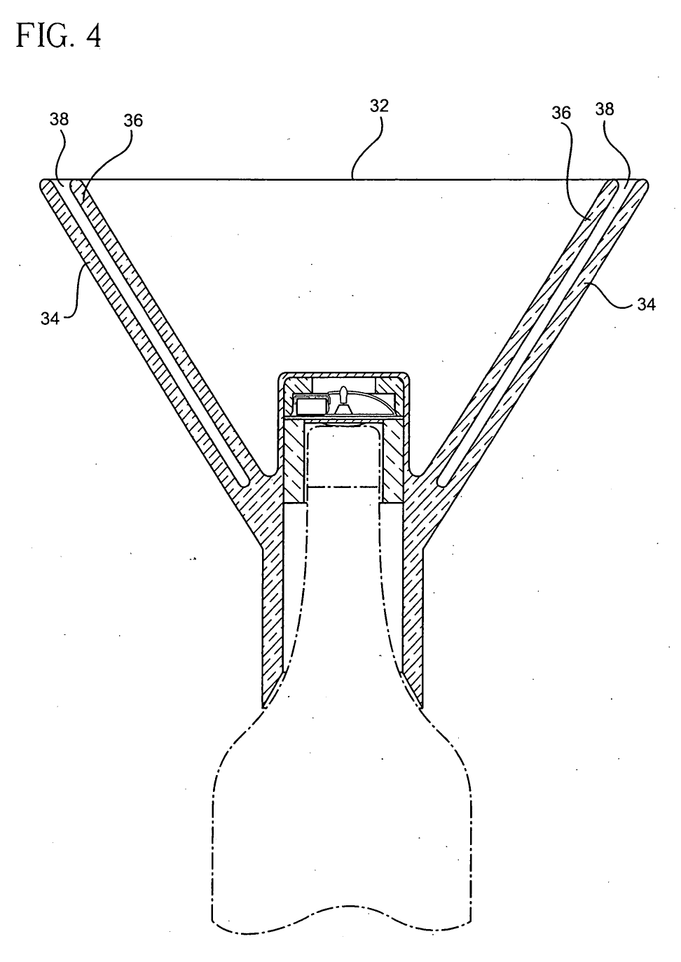

In one preferred embodiment, the sidewall of the vessel is formed such that it is actually two walls which are cooperatively parallel over the entire shape of the vessel and include an opening between the two walls. Referring to FIG. 4, there is seen a cross-sectional view of a drinking device having a double wall structure. The vessel portion 32 includes an outside wall 34, an inside wall 36 and an opening 38 between the outside and inside walls. The opening 38 is accessible by a user of the device for introducing and holding a drink-enhancing substance, e.g., water or another liquid which can be frozen in order to cool the potable liquid which is subsequently poured into the vessel portion of the device. Other substances that can be provided within the opening 38 include substances providing decorative features, such as, for example, glitter, figurines, colored objects, colored liquid or a phosphorescing substance. In an embodiment not shown, the opening can be a closed cavity that is pre-filled with water or another liquid that can be frozen, or a substance providing decorative features.

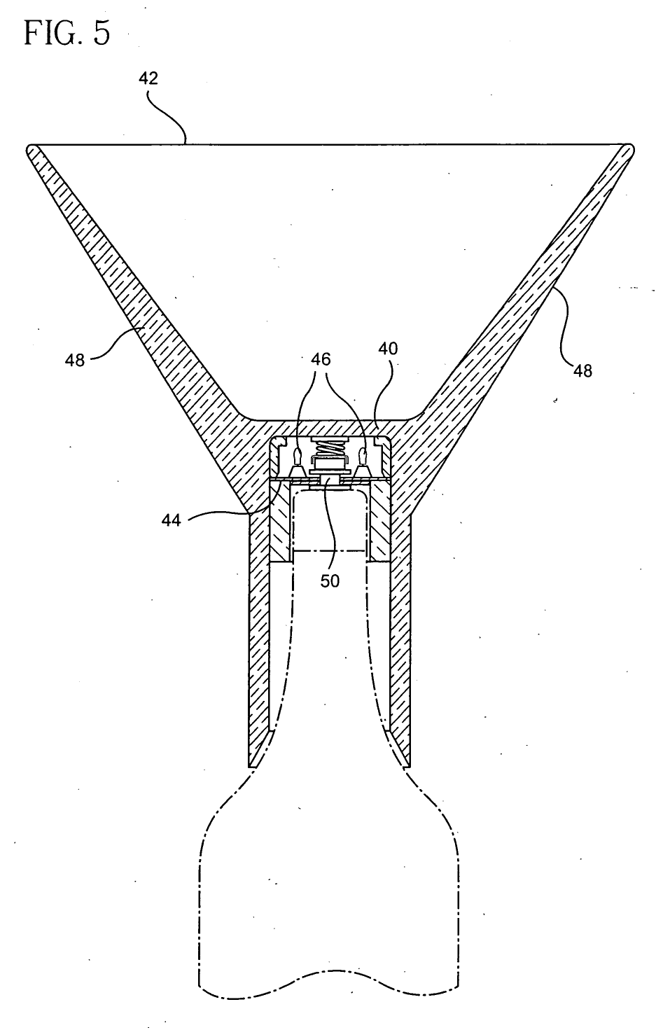

In another embodiment, the illuminator can be situated such that it radiates light within the walls of the vessel. As seen in FIG. 5, in a cross-sectional view, the bottom 40 of the vessel 42 does not extend towards the vessel opening and the illuminator 44 is situated such that the LEDs 46 radiate light through and within the vessel wall 48. The illuminator 44 includes a spring loaded switch 50 that energizes the LEDs 46 when the drinking device is detached from the potable liquid container. The LEDs 46 are de-energized or turned off when the device is fitted over and attached to the container, e.g., a 50 ml liquor bottle.

In other embodiments not shown, the illuminator can contain a switch that is operated manually to turn the light source “on” and “off,” or remotely, e.g., by radio waves. It is contemplated that the light source can emit light continuously, in a steady flashing mode or other strobe patterns.

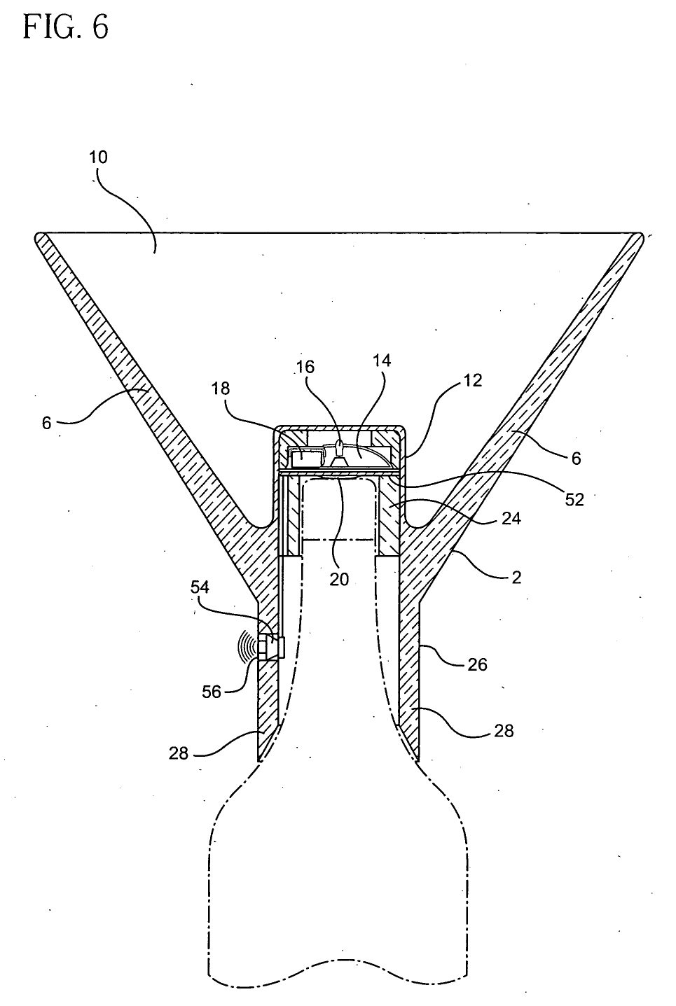

In another embodiment, the device includes a sound generator in place of or, preferably, in addition to an illuminator. As seen in FIG. 6, there is shown a drinking device similar to the drinking device shown in FIGS. 1-3, but with the addition of a sound generator. The sound generator includes a sound chip 52 that is electrically connected to a speaker 54. The sound chip 52 contains a stored or recorded sound, e.g., a song or jingle, that is replayed upon energizing the sound chip 52. The speaker 54 is imbedded in the sidewall 28 of the attachment structure 26. The portion of the sidewall 28 directly in front of the speaker 54 includes perforations 56 to allow sound to be heard from the speaker 54. The wiring 58 between the sound chip 52 and the speaker 54 passes through a groove in the retaining ring 24. The switch 20 turns both the LED 16 and the sound chip 52 “on” and “off” and the batteries 18 power both the LED 16 and the sound chip 52.

Thus, it is contemplated that the drinking device can include a sound generator, which includes sound generating integrated circuit(s) mounted to a printed circuit board as known in the art. The sound generator can generate a sound, a series of different sounds, voice recording, a tone, series of different tones, music, songs and jingles when the circuit is energized. The sound(s) are preferably pre-recorded or pre-programmed. However, it is also contemplated that the sound generator can include a microphone and be capable of recording sound and playing it back. The sound can be activated when the device is attached to a container, e.g., a bottle, or when it is detached from the container. The sound generator can also be activated by a manual switch or remotely, e.g., by radio waves. In a device containing both an illuminator and a sound generator, the device can be arranged to emit both light and sound together simultaneously, out of phase from each other or randomly. The device can also be arranged so that it emits light and no sound in one mode and emits sound and no light in another mode.

Those skilled in the art will appreciate the simple, unitary construction of the drinking device and the different lighting and sound effects that can be achieved. The drinking device of the present invention provides container and potable liquid companies with a unique device for enhancing the novelty, appearance and drinking experience through the use of lighting, sound and decorative features. To that end, as shown in FIG. 6, the vessel portion of the device can be shaped to emulate any number of vessel shapes for common potable beverages such as, for example, red wine glass, white wine glass, brandy snifter, champagne flute, frozen cocktail glass, or margarita glass, as shown in FIGS. 6(A)-(F), respectively.

What is claimed is:

1. A drinking device for use with a container of potable liquid comprising:
a) a vessel portion having a side wall and a bottom which are continuous so that a liquid can be held therein;
b) an attachment structure joined to said vessel portion for attaching said device to a container which can hold a liquid; and
c) an illuminator fixed in one of (i) said attachment structure, (ii) said vessel portion, or (iii) a combination of said attachment structure and said vessel portion, so that it can be operated to provide illumination.

2. A device according to claim 1 wherein said vessel portion emulates the shape of a top of a drinking glass selected from the group consisting of a martini glass, a wine glass, a snifter, a fluted glass, a margarita glass, and other glasses which hold alcoholic beverages.

3. A device according to claim 1 wherein said side wall further comprises an outside wall and an inside wall and an opening between said outside wall and said inside wall which is accessible by a user of the device for introducing, and holding drink-enhancing substance.

4. A device according to claim 3 wherein said drink-enhancing substance can be frozen to provide a coolant for potable liquid in said vessel portion.

5. A device according to claim 3 wherein said drink-enhancing substance provides a decorative feature to said vessel portion.

6. A device according to claim 1 wherein said side wall further comprises an outside wall, an inside wall and a closed cavity between said outside wall and said inside wall.

7. A device according to claim 6 wherein said cavity is at least partially filled with a drink-enhancing substance.

8. A device according to claim 7 wherein said drink-enhancing substance can be frozen to provide a coolant for potable liquid in said vessel portion.

9. A device according to claim 7 wherein said drink-enhancing substance provides a decorative feature to said vessel portion.

10. A device according to claim 1 wherein said attachment structure comprises:
(i) an elongated encasement extending from the outside of said vessel portion and having a shape and size to accommodate insertion of a top of said container; and
(ii) a securement for securing said device to said container.

11. A device according to claim 10 wherein said elongated encasement is a continuous wall which encircles said top of said container and which has a bottom edge which fits conformingly against the outside surface of said container at a point below said top.

12. A device according to claim 10 wherein said securement comprises a grommet fixed on the inside of said elongated encasement which is sized to grip said top of said container.

13. A device according to claim 10 wherein said securement comprises a threaded surface for receiving a screw top of said container.

14. A device according to claim 1 wherein said illuminator comprises:
(i) a light source; and
(ii) a source of electrical power connected to said light source for energizing said light source, whereby said drinking device is illuminated.

15. A device according to claim 14 wherein said illuminator further comprises a switch for turning said light source “on” and “off”.

16. A device according to claim 15 wherein said switch operates to turn said light source “on” when said device is attached to said container.

17. A device according to claim 15 wherein said switch operates to turn said light source “off” when attached to said container and to turn said light source “on” when said device is detached from said container.

18. A device according to claim 15 wherein said switch is operated manually to turn said light source “on” and “off”.

19. A device according to claim 15 wherein said switch is operated remotely to turn said light source “on” and “off”.

20. A device according to claim 19 wherein said switch is operated responsive to signals from the electromagnetic spectrum.

21. A device according to claim 15 wherein said light source provides light selected from different frequencies of the electromagnetic spectrum.

22. A device according to claim 21 wherein said light is a black light.

23. A device according to claim 15 wherein said light source is at least one light emitting diode (LED).

24. A device according to claim 15 wherein said light source is at least one light bulb.

25. A device according to claim 15 wherein said light source is positioned to provide light within the walls of said vessel portion.

26. A device according to claim 1 further comprising a sound generator fixed in one of (i) said attachment structure, (ii) said vessel portion, or (iii) a combination of said attachment structure and said vessel portion, so that said sound generator can be operated to provide a pre-selected sound.

27. A device according to claim 26 wherein said sound generator comprises:
(i) a sound chip;
(ii) a speaker; and
(iii) a source of electrical power connected to said sound chip and said speaker for energizing said sound chip and speaker, whereby said drinking device emits sound.

28. A device according to claim 27 wherein said sound generator further comprises a switch for turning said sound generator “on” and “off”.

29. A device according to claim 28 wherein said sound generator provides sound in a form selected from the group consisting of a discrete sound, a series of different sounds, a tone, series of different tones, a recorded voice, music, songs and jingles.

30. A device according to claim 26 wherein said illuminator and said sound generator share a common source of electrical power for energizing both the illuminator and the sound generator.

31. A device according to claim 30 wherein said illuminator and said sound generator share a common switch for turning them “on” and “off.”

32. A drinking device for use with a container of potable liquid comprising:
a) a vessel portion having a side wall and a bottom which are continuous so that a liquid can be held therein;
b) an attachment structure joined to said vessel portion for attaching said device to a container which can hold a liquid; and
c) a sound generator fixed in one of (i) said attachment structure, (ii) said vessel portion, or (iii) a combination of said attachment structure and said vessel portion, so that said sound generator can be operated to provide a pre-selected sound.

33. A device according to claim 32 wherein said vessel portion emulates the shape of a top of a drinking glass selected from the group consisting of a martini glass, a wine glass, a snifter, a fluted glass, a margarita glass, and other glasses which hold alcoholic beverages.

34. A device according to claim 32 wherein said attachment structure comprises:
(i) an elongated encasement extending from the outside of said vessel portion and having a shape and size to accommodate insertion of a top of said container; and
(ii) a securement for securing said device to said container.

35. A device according to claim 34 wherein said elongated encasement is a continuous wall which encircles said top of said container and which has a bottom edge which fits conformingly against the outside surface of said container at a point below said top.

36. A device according to claim 34 wherein said securement comprises a grommet fixed on the inside of said elongated encasement which is sized to grip said top of said container.

37. A device according to claim 34 wherein said securement comprises a threaded surface for receiving a screw top of said container.

38. A device according to claim 32 wherein said sound generator comprises:
(i) a sound chip;
(ii) a speaker; and
(iii) a source of electrical power connected to said sound chip and said speaker for energizing said sound chip and speaker, whereby said drinking device emits sound.

39. A device according to claim 38 wherein said sound generator further comprises a switch for turning said sound generator “on” and “off”.

40. A device according to claim 39 wherein said sound generator provides sound in a form selected from the group consisting of a discrete sound, a series of different sounds, a tone, series of different tones, recorded voice, music, songs and jingles.
